(19) United States
(12) Patent Application Publication
(10) Pub. No.: US 2025/0186900 A1
(43) Pub. Date: Jun. 12, 2025

(54) FLOW SCANNING DEVICE AND SYSTEM

(71) Applicants: HYUNDAI MOTOR COMPANY, SEOUL (KR); KIA CORPORATION, SEOUL (KR)

(72) Inventors: Hyun Jin Kim, Daegu (KR); Han Nah Song, Suwon-si (KR); Hyeon Ha Lee, Anyang-si (KR); Yong Il Cho, Seoul (KR)

(73) Assignees: HYUNDAI MOTOR COMPANY, SEOUL (KR); KIA CORPORATION, SEOUL (KR)

(21) Appl. No.: 18/646,385

(22) Filed: Apr. 25, 2024

(30) Foreign Application Priority Data
Dec. 7, 2023 (KR) 10-2023-0176159

(51) Int. Cl. B01B 1/00

(52) U.S. Cl. CPC B01B 1/005

(57) ABSTRACT

A flow scanning device and system detects clogging of a transfer line due to materials. The flow scanning system includes a first transfer line configured to transfer materials used to manufacture dry electrodes from a first zone to a second zone, and a first scanning device installed in the first transfer line and configured to detect clogging of the first transfer line by the materials based on first data obtained through a laser beam radiated to the first transfer line.

### CROSS REFERENCE TO RELATED APPLICATIONS

This application claims under 35 U.S.C. § 119 (a) the benefit of priority to Korean Patent Application No. 10-2023-0176159, filed on Dec. 7, 2023, the entire contents of which are incorporated herein by reference.

### TECHNICAL FIELD

The present disclosure relates to a flow scanning device and system. More particularly, it relates to a flow scanning device and system which detect clogging of a transfer line due to materials.

### BACKGROUND

Recently, application of rechargeable secondary batteries is expanding in various fields, from small electronic devices to large energy storage systems. In particular, research and development on secondary batteries is being actively conducted due to rapid growth of the electric vehicle market.

Electrodes for secondary batteries have generally been manufactured through a wet process. In the wet process, a slurry is manufactured by dissolving an electrode active material, a binder, and a conductive material included in the electrode with a solvent. However, a dry process, which may increase the energy density of a battery compared to the wet process without the solvent required in the wet process, has been receiving a great deal of attention now.

In the dry process for electrodes, a dry electrode film is formed by preparing a mixture by mixing an electrode active material, a conductive material, and a binder, without any solvent, and then performing film formation by pressing or calendaring. Then manufacture of an electrode may be completed by bonding the dry electrode film to a current collector.

Compared to the wet electrode manufacturing process, the dry electrode manufacturing process may reduce manufacturing time and cost because no solvent is used and may control the thickness of a film formed, thereby being capable of obtaining a dry electrode film having a high energy density.

A dry electrode undergoes a series of transfer processes during manufacturing. For example, dry electrode materials including an electrode active material, a conductive material, and a binder stored in respective tanks are transferred to a mixing zone to manufacture a dry electrode mixture. The dry electrode mixture is prepared by mixing the dry electrode materials in the mixing zone, and then the prepared dry electrode mixture is transferred to a film formation zone for film formation. Because the dry electrode materials or the dry electrode mixture all has a very large angle of repose and has the characteristic of clumping together, a transfer line can be easily clogged during transfer, and it is very difficult to detect the clogged part of the transfer line.

The above information disclosed in this Background section is only for enhancement of understanding of the background of the disclosure and therefore it may contain information that does not form the prior art that is already known to a person of ordinary skill in the art.

### SUMMARY

The present disclosure has been made in an effort to solve the above-described problems associated with the prior art, and it is an object of the present disclosure to provide a flow scanning device and system which may easily detect clogging of a transfer line due to materials during manufacture of a dry electrode.

It is another object of the present disclosure to provide a flow scanning device and system which may easily identify an area where clogging of a transfer line occurs during manufacture of a dry electrode.

The objects to be accomplished by the present disclosure are not limited to the above-mentioned objects, and other objects not mentioned herein will be clearly understood by those skilled in the art from the following description.

In one aspect, the present disclosure provides a flow scanning system including a first transfer line configured to transfer materials used to manufacture a dry electrode from a first zone to a second zone, and a first scanning device installed in the first transfer line and configured to detect clogging of the first transfer line by the materials based on first data obtained through a laser beam radiated to the first transfer line.

In another aspect, the present disclosure provides a flow scanning device. The flow scanning device is communicatively connected to a transfer line through which materials flow and configured to detect clogging of the transfer line. the flow scanning device may include a sensing tube connected to the transfer line, a transmitter disposed on the sensing tube and configured to radiate a laser beam in a radial direction of the sensing tube, a receiver disposed on the sensing tube and configured to detect laser data of the radiated laser beam, and a controller configured to receive the detected laser data and to determine the clogging of the transfer line based on the laser data.

In yet another aspect, the present disclosure provides a system for manufacturing a dry electrode, including tanks storing dry electrode materials, a mixer configured to mix the dry electrode materials supplied from the tanks to produce a dry electrode mixture, a film formation device configured to receive the dry electrode mixture from the mixer and to form the dry electrode mixture into a film, a transfer line configured to connect the tanks, the mixer and the film formation device to one another to enable transfer of the materials thereamong, and a flow scanning device installed in the transfer line and configured to detect clogging of the transfer line, wherein the flow scanning device is configured to radiate a laser beam to the transfer line and to determine the clogging of the transfer line based on a change in the laser beam having passed through the transfer line.

Other aspects and preferred embodiments of the disclosure are discussed infra.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a view briefly showing a process of manufacturing a dry electrode;

FIG. 2 is a view schematically showing transfer of materials for manufacturing the dry electrode;

FIGS. 3 and 4 are views showing a flow scanning device according to one embodiment of the present disclosure;

FIGS. 5A, 5B, 5C, 5D, 5E, 5F, 5G, and 5H are views showing a process of installing the flow scanning device according to one embodiment of the present disclosure in a transfer line;

FIG. 6 is a cross-sectional view of the flow scanning device according to one embodiment of the present disclosure;

FIG. 7 is a view showing a fixing member of FIG. 6;

FIGS. 8A, 8B, and 8C are views showing operation of the flow scanning device depending on the flow of transfer materials;

FIG. 9A shows a cross-sectional view of the flow scanning device according to one embodiment of the present disclosure and laser data measured by respective receivers when the transfer materials are not being transferred;

FIG. 9B shows a cross-sectional view of the flow scanning device according to one embodiment of the present disclosure and laser data measured by the respective receivers when the transfer materials are being transferred;

FIG. 10A shows laser data collected by a flow scanning system according to the present disclosure when the transfer materials are accumulated in the transfer line;

FIG. 10B shows laser data collected by the flow scanning system according to the present disclosure when the transfer line is clogged by the transfer materials; and

FIG. 11 is a diagram to explain a problem that may occur after transfer of the transfer materials have been completed in an angled transfer line.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Specific structural or functional descriptions in embodiments of the present disclosure set forth in the description which follows will be exemplarily given to describe the embodiments of the present disclosure, and the present disclosure may be embodied in many alternative forms. Further, it will be understood that the present disclosure should not be construed as being limited to the embodiments set forth herein, and the embodiments of the present disclosure are provided only to completely disclose the disclosure and cover modifications, equivalents or alternatives which come within the scope and technical range of the disclosure.

In the following description of the embodiments, terms, such as “first” and “second”, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers will be used throughout the drawings to refer to the same or like parts. The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

Hereinafter, reference will be made in detail to various embodiments of the present disclosure, examples of which are illustrated in the accompanying drawings and described below.

A dry electrode may be manufactured from a dry electrode mixture M and a current collector without a solvent. The dry electrode mixture M is a mixture including an electrode active material, a conductive material, and a binder. Further, the dry electrode mixture M may further include additives.

The dry electrode may be a cathode or may be an anode. In some embodiments, when a cathode is manufactured, the electrode active material may include a cathode active material. As a non-limiting example, the cathode active material may include LiCoO₂ (LCO), Li(Ni, Co, Mn)O₂ (NCM), Li(Ni, Co, Al)O₂ (NCA), LiMnO₄ (LMO), LiFePO₄ (LFP), or sulfur (S).

In some embodiments, when an anode is manufactured, the electrode active material may include an anode active material. As one example, the anode active material may include natural graphite, artificial graphite, mesocarbon microbeads (MCMB), or a silicon-based material.

The conductive material may include a carbon material. For example, the conductive material may include carbon black, acetylene black, carbon fibers, or carbon nanotubes.

The binder may include a polymer-based chemical, such as polyvinylidene fluoride (PVDF), polyvinyl alcohol (PVA), polytetrafluoroethylene (PTFE), styrene-butadiene rubber (SBR), carboxymethyl cellulose (CMC), polyacrylonitrile (PAN), or the like.

As additives, some of solid polymer electrolytes, such as poly(ethylene oxide) (PEO), or oxide or sulfide-based solid electrolytes may be used.

The dry electrode mixture M may include 70 to 99.9 wt % of the electrode active material, 0.1 to 20 wt % of the conductive material, and 0.1 to 20 wt % of the binder, as dry electrode materials. Here, the additives may be added at a rate of 0 to 20 wt %.

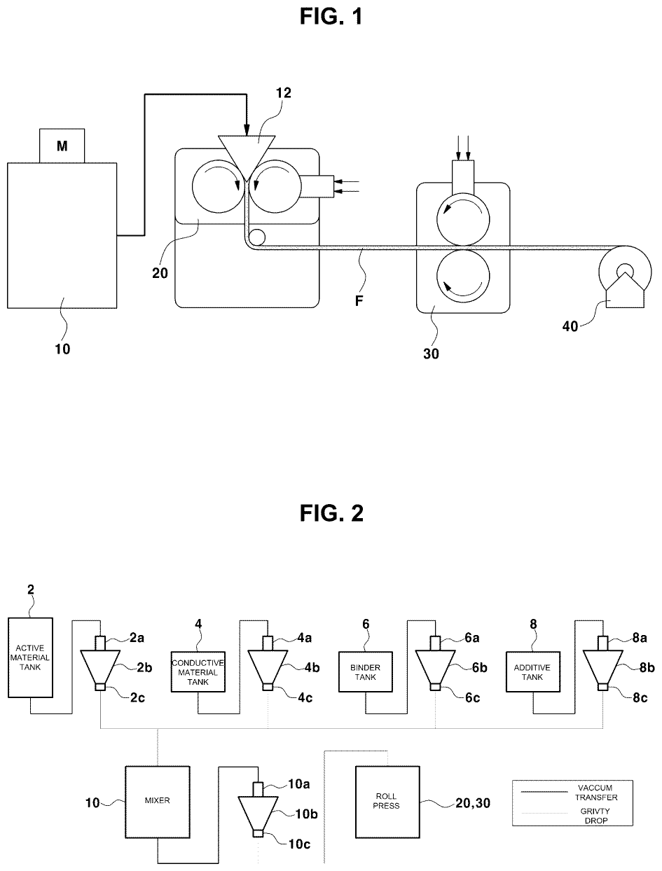

As shown in FIG. 1, the dry electrode mixture M may be manufactured into a dry electrode film F through a series of film formation processes in which heat and pressure are applied. First, the dry electrode mixture M including the electrode active material, the conductive material and the binder is mixed at a predetermined speed for a predetermined time by a mixer 10. As a non-limiting example, the dry electrode mixture M may be manufactured through a high shear mixer using rotation or a fluid mixer using air, and the predetermined time and speed may be adjusted through changes in the rotational speed and operating time of the mixer 10.

The dry electrode mixture M mixed by the mixer 10 may be formed into a film by a film formation device. Concretely, the dry electrode mixture M mixed by the mixer 10 may be directed to a feeder 12 or an upstream roll press 20. The dry electrode mixture M may be primarily pressed into a film by the upstream roll press 20. The upstream roll press 20 rotates to press the dry electrode mixture M into the film while providing pressing force thereto. The dry electrode film F primarily formed from the dry electrode mixture M may be additionally pressed by a downstream roll press 30 so that the thickness of the dry electrode film F may be adjusted through pressing. The obtained dry electrode film F is wound on a winder 40. Thereafter, a dry electrode may be manufactured by bonding or laminating the dry electrode film F to or on the current collector.

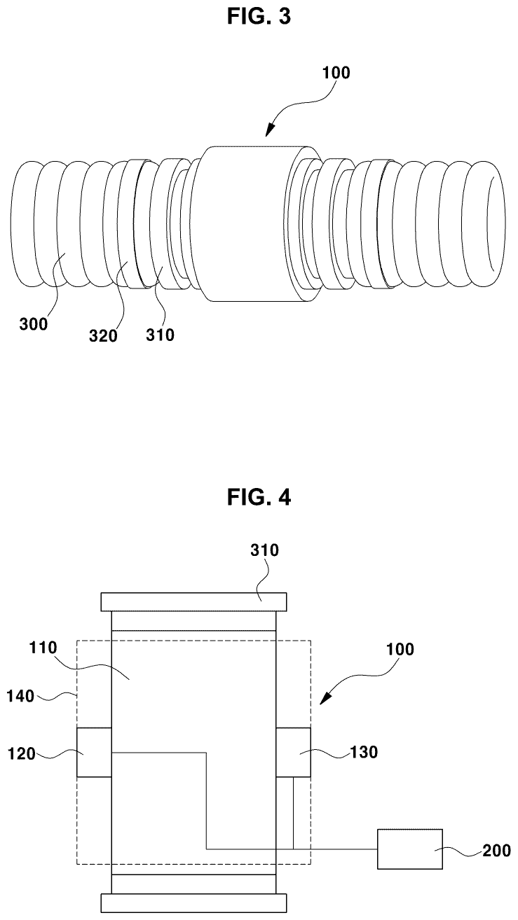

During manufacture of such a dry electrode, the materials forming the dry electrode or the dry electrode mixture M having passed through the mixing process undergoes a transfer process. As shown in FIG. 2, the dry electrode materials or the dry electrode mixture M may be vacuum-conveyed or transferred by gravity drop.

Concretely, among the materials forming the dry electrode, the electrode active material may be stored in an active material tank 2, the conductive material may be stored in a conductive material tank 4, the binder may be stored in a binder tank 6, and the additives may be stored in an additive tank 8, respectively. These materials are transferred to the mixer 10 for mixing. For example, these materials may be transferred to the mixer 10 by gravity drop.

Vacuum conveyers 2a, 4a, 6a and 8a, hoppers 2b, 4b, 6b and 8b, and meters 2c, 4c, 6c and 8c may be installed downstream of the active material tank 2, the conductive material tank 4, the binder tank 6 and the additive tank 8, respectively. The electrode materials stored in the respective tanks 2, 4, 6 and 8 are transferred to the hoppers 2b, 4b, 6b and 8b including the meters 2c, 4c, 6c and 8c through the vacuum conveyers 2a, 4a, 6a and 8a. The respective materials may be measured by the meters 2c, 4c, 6c and 8c depending on a predetermined electrode ratio and may be transferred to the mixer 10. A known vacuum conveyer system may be used as the vacuum conveyers 2a, 4a, 6a and 8a.

The dry electrode mixture M, mixing of which has been completed by the mixer 10, is transferred to a subsequent step for film formation. A vacuum conveyer 10a, a hopper 10b and a meter 10c may be also installed downstream of the mixer 10. The dry electrode mixture M measured through the meter 10c may be transferred (e.g., transferred by gravity drop) to the roll presses 20 and 30 for film formation. Otherwise, the dry electrode mixture M may be transferred to the roll presses 20 and 30 via a feeding system.

Because the materials forming the dry electrode have the characteristic of clumping together and a large angle of repose, clogging of the transfer line may occur during the above transfer process. For example, when clogging of the transfer line occurs, a solution of replacing the entire section of the transfer line where clogging occurs by measuring the pressure of the transfer line may be used. However, replacement costs are high due to the length of the transfer line, which makes this solution impractical. As another solution, a transfer line formed of a transparent material may be used. The purpose of use of the transparent transfer line is to look inside the transfer line, but in the case of the electrode materials, the inside of the transfer line is coated black after just one transfer, and thus, it is difficult to continuously observe the inside of the transfer line. As yet another example, a sight glass may be applied. Like the transparent transfer line, the sight glass is also coated black after just one transfer of the electrode materials, making internal observation difficult. In addition, when the transfer line is not clogged suddenly, but the transfer materials gradually accumulate over time, it is difficult to detect accumulation of the materials, and thus, an error in the ratio of the materials forming the dry electrode or errors in weights of the materials may occur during transfer.

Accordingly, the present disclosure seeks to provide a flow scanning device which may easily detect clogging of a transfer line due to transfer materials transferred during manufacture of a dry electrode.

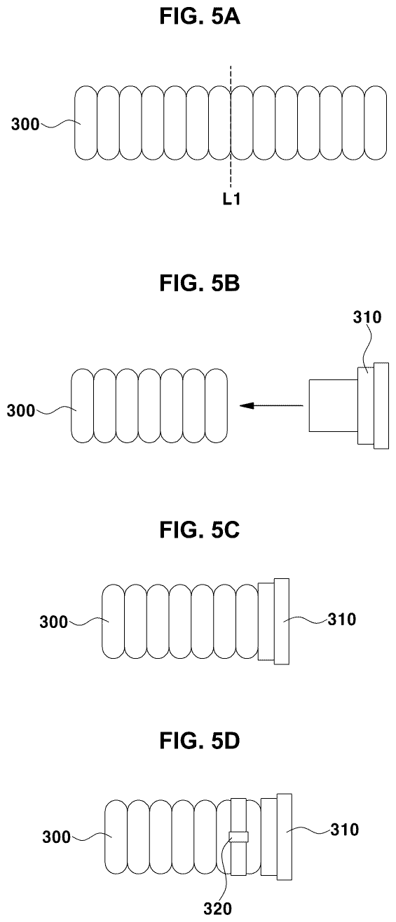

Referring to FIG. 3, a flow scanning device 100 according to one embodiment of the present disclosure may be installed in a transfer line 300. As will be described later, the flow scanning device 100 may be easily assembled at any position of the transfer line 300.

As shown in FIG. 4, the flow scanning device 100 according to one embodiment of the present disclosure includes a sensing tube 110, a transmitter 120 and a receiver 130.

The sensing tube 110 is configured to be connected to the transfer line 300. The sensing tube 110 may be easily installed at a desired position of the transfer line 300 by connectors 310. The sensing tube 110 is connected to the transfer line 300 so that transfer materials P, such as dry electrode materials or a dry electrode mixture, are transferred through the sensing tube 110. The sensing tube 110 is configured such that a laser beam to detect clogging passes through the sensing tube 110. For this purpose, the sensing tube 110 is formed of a material through which a laser beam having a specific wavelength may pass. For example, the laser beam may have a wavelength in the range of 300 nanometers to 10,000 nanometers. As lasers, CO₂ or fiber lasers using infrared light, green lasers using visible light, ultraviolet lasers using ultraviolet light, or the like may be used.

The transmitter 120 is mounted on the sensing tube 110. For example, the transmitter 120 may be mounted on the outer surface of the sensing tube 110. The transmitter 120 may be mounted on the sensing tube 110 and may radiate a laser beam to pass through the sensing tube 110. The laser beam radiated by the transmitter 120 may pass through the sensing tube 110 in the radial direction of the sensing tube 110.

The receiver 130 is mounted on the sensing tube 110. For example, the transmitter 120 may be mounted on the outer surface of the sensing tube 110. In one embodiment, the receiver 130 may be mounted on the sensing tube 110 to face the transmitter 120. The receiver 130 may receive the laser beam radiated by the transmitter 120 and having passed through the sensing tube 110 and may measure laser data. The laser data may be an intensity or count of a laser beam received by the receiver 130 with respect to time.

The intensity of the laser beam may be determined based on the area of the laser beam received by the receiver 130. For example, the receiver 130 may include a plurality of sensors which detects the received laser beam. In case that there is no interference between the transmitter 120 and the receiver 130 (for example, in case that the transfer materials P are not transferred) when a laser beam is radiated by the transmitter 120, substantially all of the laser beam radiated by the transmitter 120 may reach the receiver 130. On the other hand, in case there are transfer materials P between the transmitter 120 and the receiver 30, only some of the plurality of sensors of the receiver 130 may detect the laser beam radiated by the transmitter 120. That is, as the transfer materials P between the transmitter 120 and the receiver 130 increase, the number of sensors in the receiver 130 which detect the laser beam decreases. Therefore, the intensity of the laser beam may be measured as a ratio of the number of sensors which detect the laser beam to all the sensors included in the receiver 130.

The count of the laser beam may be defined as the number of times the receiver 130 detects the laser beam radiated by the transmitter 120 per time. For example, the presence or amount of the transfer materials P may be estimated based on the number of times the receiver 130 detects the laser beam radiated by the transmitter 120 per second.

The flow scanning device 100 further includes a controller 200. The controller 200 may be connected to a power source to supply power to the transmitter 120 and the receiver 130. Further, the controller 200 may collect laser data measured by the receiver 130.

The flow scanning device 100 may further include a sleeve 140. The sleeve 140 may be disposed to surround the sensing tube 110, the transmitter 120 and the receiver 130 to protect the same.

The flow scanning device 100 may further include the connectors 310. The connectors 310 may be coupled to the respective ends of the sensing tube 110. The connectors 310 may enable connection to the transfer line 300. As a non-limiting example, the connectors 310 may be formed of stainless steel. As another non-limiting example, the connectors 310 may be formed of a metal plating or alloy material that has low reactivity with the transfer materials P used in the transfer process.

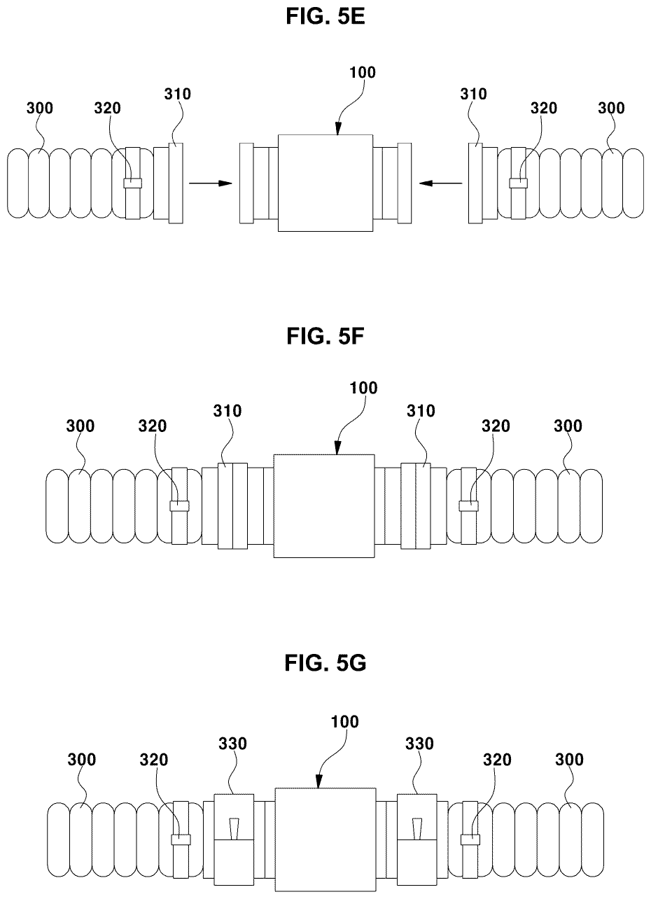

Referring to FIGS. 5A, 5B, 5C, 5D, 5E, 5G, and 5H, the flow scanning device 100 according to the present disclosure may be mounted at any position of the transfer line 300. For example, the flow scanning device 100 has an advantage of being applied to an already established transfer line.

As shown in FIG. 5A, the transfer line 300 is cut at a predetermined cutting position L1. As shown in FIGS. 5B and 5C, a connector 310 is coupled to one cut end of the transfer line 300. The connector 310 coupled to the transfer line 300 may be a pair with one of the connectors 310 coupled to the respective ends of the flow scanning device 100. As shown in FIG. 5D, a reinforcing member 320 may be coupled to the portion where the transfer line 300 and the connector 310 are coupled. The reinforcing member 320 may strengthen coupling between the connector 310 and the transfer line 300 to prevent formation of a gap therebetween. As a non-limiting example, the reinforcing member 320 may be a cable tie. The cable tie may be formed of a metal or plastic. Referring to FIGS. 5E and 5F, the flow scanning device 100 may be connected to the transfer line 300 to which the connector 310 is coupled. As shown in FIG. 5G, a clamp 330 may be further fastened to a connection region between the connectors 310. The flow scanning device 100 installed in the transfer line 300 may be connected to the controller 200 so that the controller 200 may monitor clogging of the transfer line 300 (with reference to FIG. 5H).

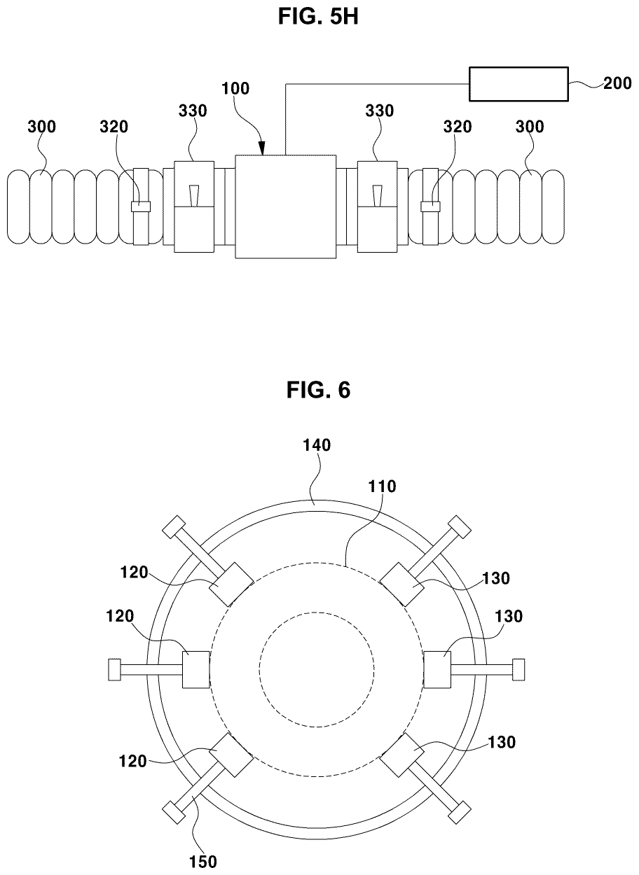

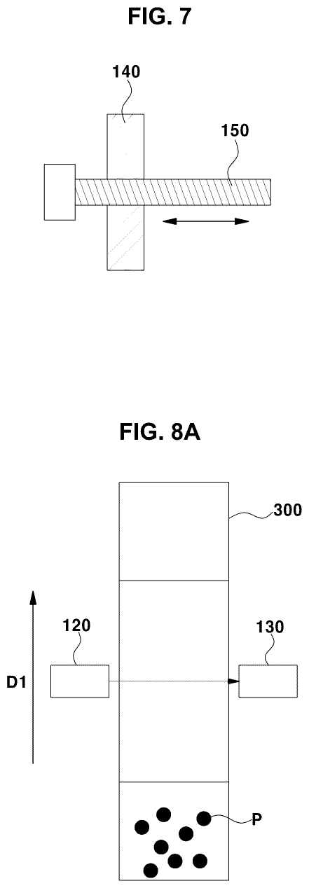

As such, the flow scanning device 100 according to the present disclosure provides an advantage of being able to be installed at any position of the transfer line 300 by cutting the transfer line 300. Moreover, in some embodiments, the positions of the transmitter 120 and the receiver 130 with respect to the sleeve 140 may be adjusted to be adapted to transfer lines 300 with different diameters, as shown in FIGS. 6 and 7.

In one embodiment, the transmitter 120 and the receiver 130 are coupled to the sleeve 140 through fixing members 150. The transmitter 120 and the receiver 130 are disposed to contact the surface of the sensing tube 110. The position of the transmitter 120 or the receiver 130 with respect to the sleeve 140 may be adjusted by adjusting the fixing member 150. In some embodiments, the fixing member 150 may include a screw. This method may flexibly respond to different diameters of the transfer line 300 by replacing only the sensing tube 110 and the connectors 310. In some embodiments, the transmitter 120 and the receiver 130 may be attached to the surface of the sensing tube 110 via magnetic stickers.

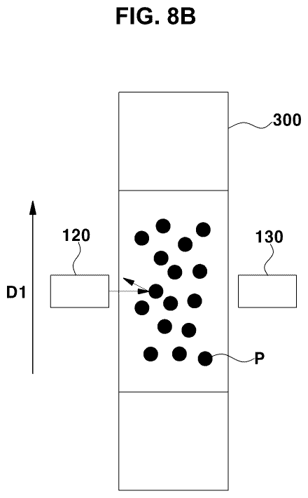

The flow scanning device 100 installed in the transfer line 300 may detect clogging of the transfer line 300 by the transfer materials P. When the transfer materials P are passing through the flow scanning device 100, the transmitter 120 radiates a laser beam, and the receiver 130 receives the radiated laser beam. As shown in FIG. 8A, before the transfer materials P pass through the flow scanning device 100 or when the transfer materials P are not present in the sensing tube 110, the transfer line 300 is empty. Under this circumstance, the laser beam emitted from the transmitter 120 is received directly by the receiver 130. Further, there is no change in laser data measured by the receiver 130. For example, the intensity of the laser beam detected by the receiver 130 may be substantially the same as the intensity of the laser beam radiated by the transmitter 120. As shown in FIG. 8B, when the transfer materials P is passing through the flow scanning device 100 or when the transfer materials P is present in the sensing tube 110, the laser beam emitted from the transmitter 120 collides with the transfer materials P and may thus move in a direction other than going straight. Therefore, in this case, laser data received by the receiver 130 may be different from the transmitted laser data, or its value may not be detected. Thereby, when the transfer materials P are located in the transfer line 300, the intensity or count of the laser beam measured by the receiver 130 may decrease or may not be measured. Further, as shown in FIG. 8C, after the transfer materials P passes through the flow scanning device 100, the laser beam from the transmitter 120 may travel straight in the radial direction of the transfer line 300 and may be received directly by the receiver 130. Here, D1 indicates the transfer direction of the transfer materials P.

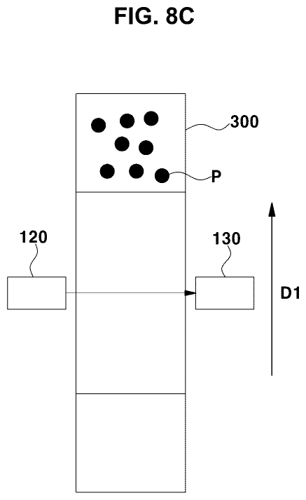

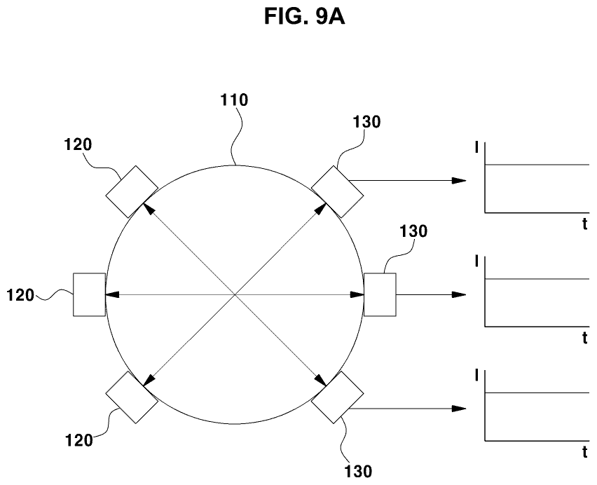

As shown in FIGS. 9A and 9B, the flow scanning device 100 may include a plurality of transmitters 120 and a plurality of receivers 130. In one embodiment, a plurality of pairs of transmitters 120 and receivers 130 may be disposed in one flow scanning device 100.

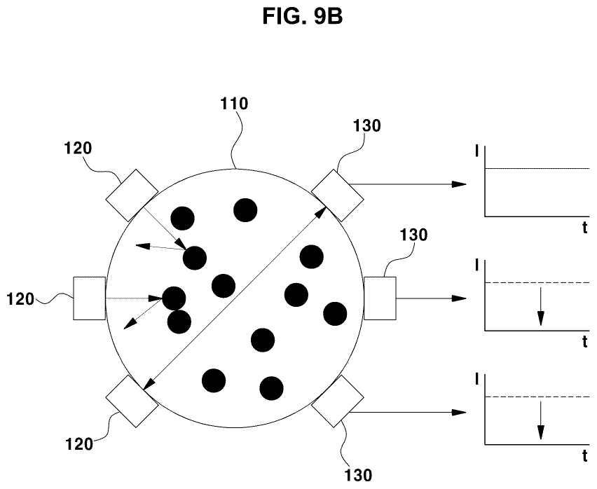

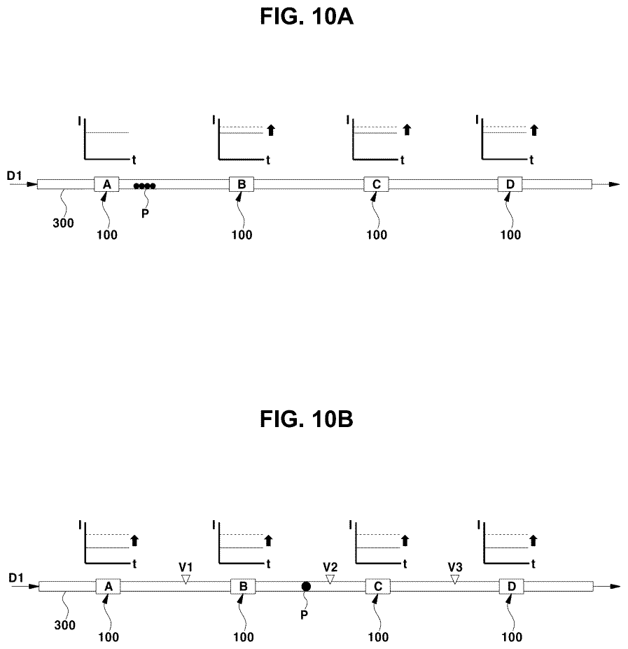

When each of the transmitters 120 radiates a laser beam, a corresponding one of the receivers 130 measures laser data for the radiated laser beam. When the transfer materials P are not being transferred, as shown in FIG. 9A, the laser beam may reach the receivers 130 without any obstruction, and the measured laser data does not change. However, as shown in FIG. 9B, when the transfer materials P are present in the sensing tube 110 and interfere with a path through which the laser beam passes, reflection, scattering, diffraction, refraction, etc., of the laser beam occur, and the intensity or count of the laser beam reaching the receiver 130 vary. When clogging of the transfer line 300 occurs upstream of the flow scanning device 100, the laser beam reaches the receiver 130 without any obstruction, so the controller 200 may determine clogging of the transfer line 300 upstream of the flow scanning device 100 based on the measured laser data. Also, the controller 200 may easily determine that the transfer materials P are gradually accumulated on the inner surface of the transfer line 300 since the laser data measured by the receiver 130 changes. Referring to FIG. 10A, when the transfer materials P gradually accumulate in the transfer line 300, which causes the transfer line 300 to be clogged, it may be possible to determine clogging of the transfer line 300 by a flow scanning system according to the present disclosure.

FIG. 10A shows the transfer line 300 through which the transfer materials P are transferred in the transfer direction D1, and flow scanning devices 100 are disposed at points A, B, C and D, respectively. As illustrated, if the transfer materials P are accumulating between the points A and B, laser data I (e.g., the intensity or count of the laser beam) measured at the point A is not changed over time t. However, the amount of the transfer materials P passing through each of the points B, C and D is decreased, and thus, laser data I measured at the points B, C and D is increased compared to the laser data I measured at the point A as indicated by arrows. The controller 200 may easily determine that clogging has occurred in a section between the points A and B based on the collected laser data I.

FIG. 10B illustrates a case in which the transfer line 300 is completely clogged by the transfer materials P. When clogging by the transfer materials P occurs between the points B and C, the transfer materials P are not transferred in the entire section even if a vacuum is formed. Even when vacuum transfer is taking place, laser data is not observed, based on which the controller 200 may determine that clogging has occurred in the transfer line 300. That is, when there is no flow of the transfer materials P, the intensity or count of the laser beam detected by the flow scanning device 100 is increased compared to when the transfer materials P are being transferred at the points A, B, C and D.

As such, when clogging occurs in the transfer line 300, according to the present disclosure, it is possible to determine specifically at which point clogging has occurred. In order to determine at which point in the transfer line 300 clogging has occurred, a fine hole is formed in the transfer line 300 at each of points V1, V2 and V3. When the transfer materials P are injected through the hole formed at the point V1 and laser data are measured at the points B, C and D, it may be determined that clogging has occurred upstream of the point V1. However, in the illustrated example, laser data will be measured at the point B, but laser data will not be measured by the flow scanning devices 100 at the points C and D. Accordingly, it may be determined that the section between the points B and C is clogged. The holes formed to detect the position of clogging may be filled by a known method.

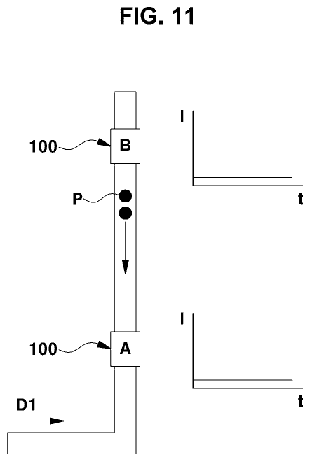

According to the present disclosure, it may be possible to determine a vacuum time required to transfer the transfer materials P. As shown in FIG. 11, the transfer materials P transferred in the transfer direction D1 should no longer be present inside the transfer line 300 when vacuum transfer is completed. In this respect, laser data I indicating presence of the transfer materials P should not be detected by the flow scanning devices 100 at the points A and B. However, when the vacuum time needed for transfer is not sufficient, the transfer materials P, which cannot move after completion of vacuum formation, fall due to gravity. That is, the falling transfer materials P, which flow backward, may be detected by the flow scanning device 100. According to the present disclosure, a vacuum formation time is adjusted through such detection, thereby preventing the transfer materials P from flowing backward and accumulating.

According to some embodiments of the present disclosure, a flow scanning system in which a plurality of flow scanning devices 100 is disposed on a transfer line 300 may be provided. The controller 200 may receive laser data from the respective flow scanning devices 100 and may detect clogging of the transfer line 300 based on the received laser data. Further, it may be determined at which point in the transfer line 300 clogging has occurred based on the detected laser data. Therefore, according to the present disclosure, partial replacement of the transfer line 300 is possible without replacement of the entire section of the transfer line 300.

In case of a section of the transfer line 300 which is not straight but is curved or angled, clogging may be continuously observed by the flow scanning system. A vibrator or a cooling jacket may be installed in the section where clogging is continuously observed. The vibrator may generate vibration in the flow scanning system to alleviate clumping during transfer. The cooling jacket may lower the temperature of the transfer line 300 to suppress the tendency of the transfer materials P having clumping properties to stick to the transfer line 300. Additionally, the vacuum time required to transfer the transfer materials P may be adjusted by identifying a section where the transfer materials P flow backward after termination of the vacuum.

Although the flow scanning device 100 is described herein as being used in manufacture of dry electrodes, this is illustrative and the flow scanning device 100 may also be applied to manufacture of other materials.

The flow scanning device and system according to the present disclosure may detect clogging of a transfer line due to flowing transfer materials and may determine at which part of the transfer line clogging has occurred, thereby being capable of saving time and cost.

In addition, the flow scanning device according to the present disclosure is simple to install and provides an advantage of being applicable to already established transfer lines.

Ultimately, the flow scanning device and system according to the present disclosure enable effective operation of a dry electrode manufacturing line.

As is apparent from the above description, the present disclosure provides a flow scanning device and system which may easily detect clogging of a transfer line due to materials during manufacture of a dry electrode.

Further, the present disclosure provides a flow scanning device and system which may easily identify at which part of a transfer line clogging has occurred during manufacture of a dry electrode.

The effects of the present disclosure are not limited to the above-mentioned effects, and other effects not mentioned herein will be clearly understood by those skilled in the art from the above description.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

1. A flow scanning system comprising:
a first transfer line configured to transfer materials used to manufacture a dry electrode from a first zone to a second zone; and
a first scanning device positioned in the first transfer line and configured to detect clogging of the first transfer line by the materials based on first data obtained through a laser beam radiated to the first transfer line.

2. The system of claim 1, further comprising:
a second transfer line communicatively connected to the first transfer line and configured to transfer the materials from the second zone to a third zone; and
a second scanning device positioned in the second transfer line and configured to detect clogging of the second transfer line by the materials based on second data obtained through a laser beam radiated to the second transfer line.

3. The system of claim 2, further comprising a controller, wherein a controller is configured to:
collect the first data detected by the first scanning device and the second data detected by the second scanning device; and
determine the clogging of the first transfer line or the second transfer line based on the collected first and second data.

4. The system of claim 3, wherein the controller is configured to determine that the clogging of the first transfer line or the second transfer line has occurred in response to determining that a change between the first data and the second data deviates from a predetermined range.

5. The system of claim 3, further comprising:
a third transfer line communicatively connected to the second transfer line and configured to transfer the materials from the third zone to a fourth zone; and
a third scanning device positioned in the third transfer line and configured to detect clogging of the third transfer line by the materials based on third data obtained through a laser beam radiated to the third transfer line;
wherein the controller is configured to collect the third data and to determine the clogging of the third transfer line based on the third data.

6. The system of claim 5, wherein the controller is configured to determine that the clogging of the first transfer line, the second transfer line, or the third transfer line has occurred, in response to determining that a change among the first data, the second data, and the third data deviates from a predetermined range.

7. The system of claim 6, wherein the controller is configured to determine that a section where clogging has occurred among the first transfer line, the second transfer line, and the third transfer line is an upstream section of one of the first, second, and third scanning devices where the change is first detected.

8. The system of claim 5, wherein each of the first scanning device, the second scanning device, and the third scanning device comprises:
a transmitter configured to radiate a laser beam in a radial direction of the first transfer line, the second transfer line, or the third transfer line; and
a receiver configured to receive laser data of the laser beam radiated by the transmitter.

9. The system of claim 1, wherein the materials comprise an active material, a conductive material, a binder, and a mixture thereof.

10. The system of claim 1, wherein the materials are configured to be vacuum-conveyed or transferred by gravity drop.

11. A flow scanning device communicatively connected to a transfer line through which materials flow and configured to detect clogging of the transfer line, the flow scanning device comprising:
a sensing tube connected to the transfer line;
a transmitter disposed on the sensing tube and configured to radiate a laser beam in a radial direction of the sensing tube;
a receiver disposed on the sensing tube and configured to detect laser data of the radiated laser beam; and
a controller configured to receive the detected laser data and to determine the clogging of the transfer line based on the laser data.

12. The device of claim 11, further comprising a sleeve surrounding the sensing tube.

13. The device of claim 12, wherein the transmitter and the receiver are configured such that positions of the transmitter and the receiver with respect to the sleeve are adjustable.

14. The device of claim 11, further comprising connectors for connection to the transfer line.

15. The device of claim 11, wherein the transfer materials are dry electrode materials comprising an active material, a conductive material, and a binder, or a dry electrode mixture obtained by mixing the dry electrode materials.

16. The device of claim 11, wherein the controller is configured to determine the clogging of the transfer line based on a change between first information of the laser beam radiated by the transmitter and second information of a laser beam received by the receiver.

17. A system for manufacturing a dry electrode, comprising:
a tank storing dry electrode materials;
a mixer configured to mix the dry electrode materials supplied from the tank to produce a dry electrode mixture;
a film formation device configured to receive the dry electrode mixture from the mixer and to form the dry electrode mixture into a film;
a transfer line configured to connect the tank, the mixer, and the film formation device to one another to enable transfer of the materials; and
a flow scanning device positioned in the transfer line and configured to detect clogging of the transfer line, wherein the flow scanning device is configured to:
radiate a laser beam to the transfer line; and
determine the clogging of the transfer line based on a change in the laser beam having passed through the transfer line.

18. The system of claim 17, wherein the flow scanning device comprises:
a transmitter configured to radiate the laser beam; and
a receiver configured to receive the radiated laser beam and to measure an intensity of the laser beam or a number of times of the laser beam detected per time;
wherein the flow scanning device is configured to determine that the transfer line is at least partially clogged in response to determining that a change in the intensity or the number of times of the laser beam occurs during transfer of the materials by the transfer line.

19. A battery comprising a dry electrode manufactured by the system of claim 17.
